(19) United States
(12) Patent Application Publication
(10) Pub. No.: US 2026/0339795 A1
(43) Pub. Date: Oct. 29, 2026

(54) VIA REPAIR USING REDUNDANT VIAS

(71) Applicant: Micron Technology, Inc., Boise, ID (US)

(72) Inventors: Chan H. Yoo, Boise, ID (US); Walter L. Moden, Boise, ID (US); Christopher D. Glancey, Boise, ID (US); Michael B. Morse, Boise, ID (US)

(21) Appl. No.: 19/576,807

(22) Filed: Mar. 24, 2026

Related U.S. Application Data
(60) Provisional application No. 63/794,206, filed on Apr. 24, 2025.

(51) Int. Cl. G06F 11/20

(52) U.S. Cl. CPC G06F 11/2017

(57) ABSTRACT

Methods, systems, and devices for via repair using redundant vias are described. A memory system may include a set of signal pads coupled with a memory die. A first signal pad may be coupled with a switching component, which may be coupled with multiple conductive paths through one or more inputs of the switching component. The memory system may transmit a signal via a first conductive path of a set of conductive paths associated with the first signal pad of the memory die. The set of conductive paths may include at least the first conductive path and a second conductive path. Based on a determined performance characteristic associated with the first conductive path, the memory system may select, via the switching component, the second conductive path to couple with the first signal pad (e.g., coupling the first signal pad with the second conductive path via the switching component).

### CROSS REFERENCE

The present Application for Patent claims priority to U.S. Patent Application No. 63/794,206 by Yoo et al., entitled “VIA REPAIR USING REDUNDANT VIAS,” filed Apr. 24, 2025, which is assigned to the assignee hereof, and which is expressly incorporated by reference in its entirety herein.

### TECHNICAL FIELD

The following relates to one or more systems for memory, including via repair using redundant vias.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports via repair using redundant vias in accordance with examples as disclosed herein.

FIG. 2 shows an example of an architecture that supports via repair using redundant vias in accordance with examples as disclosed herein.

FIG. 3 shows a block diagram of a memory system that supports via repair using redundant vias in accordance with examples as disclosed herein.

FIGS. 4 and 5 show flowcharts illustrating a method or methods that support via repair using redundant vias in accordance with examples as disclosed herein.

### DETAILED DESCRIPTION

Some memory systems may include memory dies that are susceptible to defects such as cracks. For example, memory dies may include substrate vias (e.g., through silicon vias (TSVs)) that may crack as a result of manufacturing processes, field use, or both. In some cases, a faulty via (e.g., a cracked substrate via) may increase an error rate or the susceptibility of an error occurring at a corresponding memory die (e.g., due to a decreased ability to transfer electrical signals at the memory die). Accordingly, faulty vias may reduce a performance of a memory system. Faulty vias may also cause field failures of memory dies and may further cause relatively early end of life (e.g., complete failure or inoperability) of memory components (e.g., in a field setting), thereby increasing electronic waste. Accordingly, techniques for repairing faulty vias within memory dies are desirable.

A memory system may include one or more memory dies that implement substrate via crack repair by implementing redundant vias (e.g., replacing cracked substrate vias with redundant vias by switching electrical signal routing from a faulty via to a redundant via). The memory system may include a set of signal pads coupled with a memory die. A first signal pad may be coupled with a switching component (e.g., a selection component, a multiplexer), which may be coupled with multiple conductive paths (e.g., a first via and a second via, such as a redundant via) through one or more inputs of the switching component. The switching component may be located at or near one or more bond pads of the memory die.

In some implementations, the memory system may transmit a signal via a first conductive path (e.g., a first via) associated with the first signal pad of the memory die. The set of conductive paths (e.g., vias, traces) may include at least the first conductive path and a second conductive path. In some instances, the memory system may determine a performance characteristic associated with the first conductive path. As used herein, a performance characteristic may refer to a measure associated with one or more conductive paths (e.g., vias, traces). For example, a performance characteristic of a conductive path may be a signal measurement (e.g., a measurement of signal quality, power, voltage, or the like) corresponding to a signal transmitted via the conductive path. Additionally, or alternatively, a performance characteristic may be a measure (e.g., a quantity) of one or more defects (e.g., cracks, faults) associated with the conductive path. Similarly, a performance characteristic may be an indicator that the conductive path is unable (or able) to transmit signals for a memory die.

Based on the determined performance characteristic, the memory system may select, via the switching component, the second conductive path to couple with the first signal pad. That is, the switching component (e.g., the multiplexer) may couple the first signal pad with the second conductive path. Accordingly, the memory system may provide at least one redundant via for each signal pad of a memory die, and may use a redundant via for a signal pad if the first via becomes faulty (e.g., if the first via induces errors or unreliable data) or otherwise experiences a degradation in its performance. Such techniques (e.g., processes) may be applied during component testing, during use (e.g., field use), during maintenance procedures (e.g., routine repair maintenance) of systems including such memory dies, or any combination thereof to improve the overall performance of an associated memory system by reducing or eliminating the occurrence or likelihood of errors due to faulty vias.

In addition to applicability in memory systems as described herein, techniques for via repair using redundant vias may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing at least one redundant via for a signal pad of a memory die, which may allow a memory device to reselect to the redundant via when a first via becomes faulty, which may allow a memory device to reduce errors associated with memory dies. Reducing such errors may decrease processing times, improve response times, and increase memory reliability, among other benefits.

In addition to applicability in memory systems as described herein, techniques for via repair using redundant vias may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by providing at least one redundant via for a signal pad of a memory die, which may allow a memory device to reselect to the redundant via when a first via becomes faulty, which may reduce field failures of memory dies due to component substrate via cracks and may reduce electronic waste and expensive replacement, among other benefits.

Features of the disclosure are illustrated and described in the context of systems, devices, and circuits. Features of the disclosure are further illustrated and described in the context of an architecture and flowcharts.

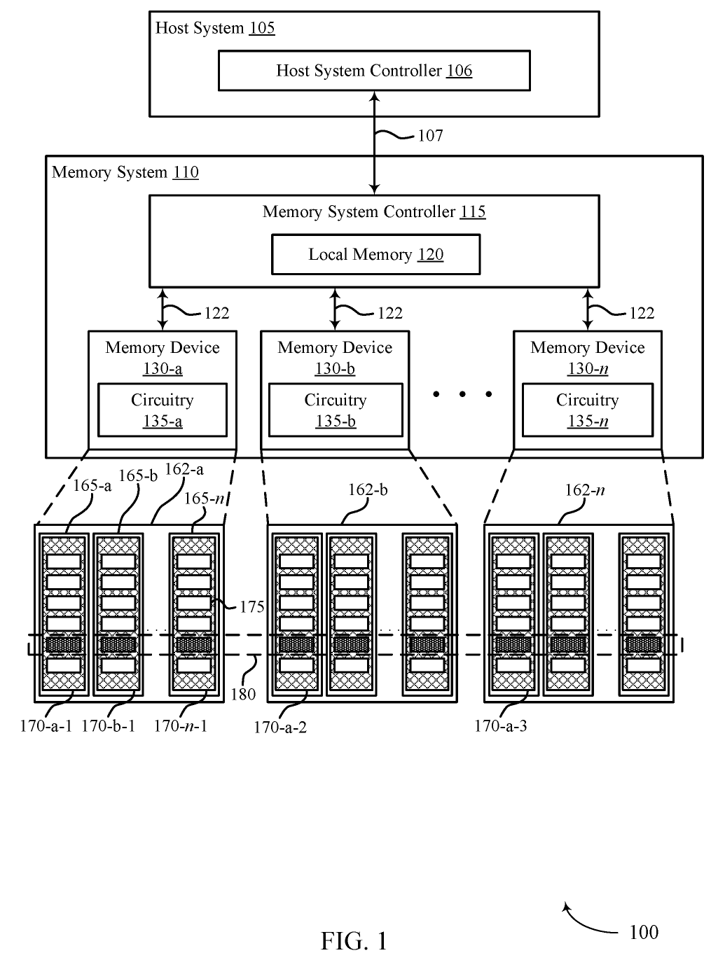

FIG. 1 shows an example of a system 100 that supports via repair using redundant vias in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0” of a first plane of die 162-a, block 170-a-2 may be “block 0” of a first plane of die 162-b, block 170-a-3 may be “block 0” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some implementations, as described herein, the memory system 110 may include one or more memory dies 162 that implement substrate via crack repair by implementing redundant vias. The memory system 110 may include a set of signal pads coupled with a memory die 162. A first signal pad may be coupled with a switching component (e.g., a selection component, a multiplexer), which may be coupled with multiple conductive paths (e.g., a first via and a second via such as a redundant via) through one or more inputs of the switching component. In some implementations, the memory system 110 may transmit a signal via a first conductive path (e.g., a first via) associated with the first signal pad of the memory die 162. The set of conductive paths may include at least the first conductive path and a second conductive path. In some instances, the memory system 110 may determine a performance characteristic associated with the first conductive path. Based on the determined performance characteristic, the memory system 110 may select, via the switching component, the second conductive path to couple with the first signal pad. That is, the switching component (e.g., the multiplexer) may couple the first signal pad with the second conductive path. Thus, the memory system 110 may provide at least one redundant via for each signal pad of a memory die 162, and may use a redundant via for a signal pad if the first via becomes faulty (e.g., if the first via induces errors or unreliable data) or otherwise experiences a degradation in its performance.

As described herein, the term “performance characteristic” may refer to a measure associated with one or more conductive paths (e.g., vias, traces). For example, a performance characteristic of a conductive path may be a signal measurement (e.g., a measurement of signal quality, power, voltage, or the like) corresponding to a signal transmitted via the conductive path. Additionally, or alternatively, a performance characteristic may be a measure (e.g., a quantity) of one or more defects (e.g., cracks, faults) associated with the conductive path. Similarly, a performance characteristic may be an indicator that the conductive path is unable (or able) to transmit signals for a memory die (e.g., reliably). As described herein, the term “defect” may refer to an anomaly or an abnormality in a conductive path (e.g., a via or a trace) or in a memory die. For example, a defect may refer to any aspect of a conductive path or a memory die that inhibits or prevents reliable signal transmission, such as a crack, a dent, a rift, a fracture, or the like.

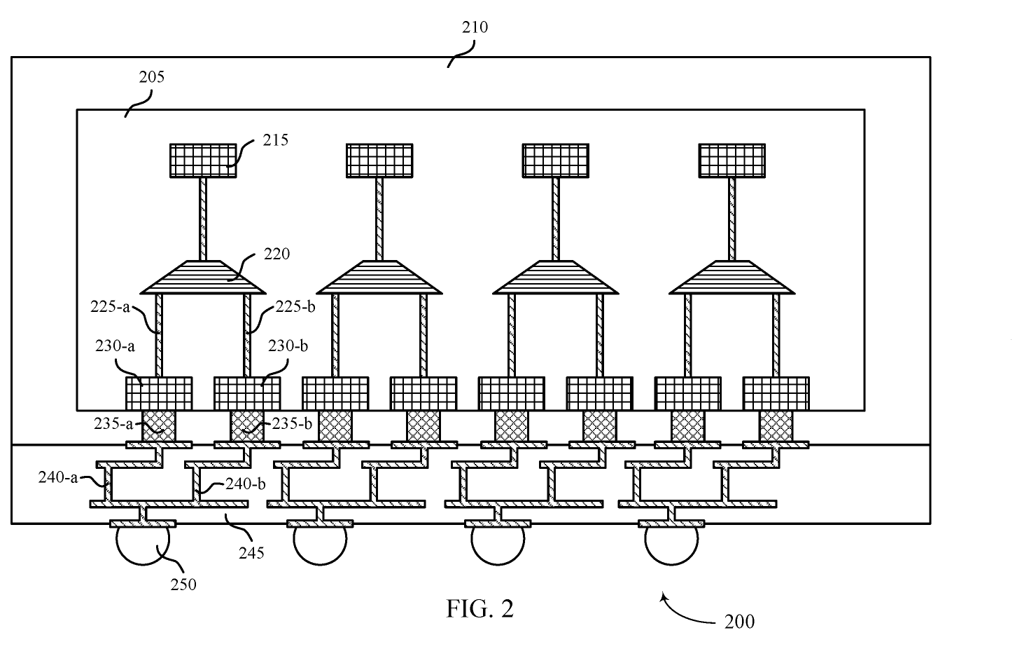

FIG. 2 shows an example of an architecture 200 that supports via repair using redundant vias in accordance with examples as disclosed herein. The architecture 200 includes a memory die 205 within a mold material 210. As described herein, a memory system 110 may include multiple memory dies similar to the memory die 205 illustrated in the architecture 200. Accordingly, the memory die 205 may be an example of a memory die 162 (e.g., as described with reference to FIG. 1). The memory die 205 may include a set of signal pads 215 (e.g., one or more signal pads 215, bond pads). Although four signal pads are shown for illustration, the memory die 205 may include a greater quantity of signal pads. In some cases, the memory die 205 may include a set of memory elements (e.g., memory cells). Each signal pad 215 may be coupled with a respective memory element (e.g., a memory cell, a group of memory elements) of the set of memory elements. As described herein, a signal pad 215 may be configured to communicate signals for reading or writing logical values at a cell of the memory die 205. Accordingly, each signal pad 215 of the set of signal pads 215 may be coupled with the memory die 205.

The architecture 200 may include a set of conductive paths 225 associated with a first signal pad 215 (e.g., coupled with a first memory element of the set of memory elements). The set of conductive paths 225 may include a first conductive path 225-a and a second conductive path 225-b (and, in some cases, one or more other conductive paths 225 such as multiple redundant paths). The architecture 200 further illustrates a first switching component 220 (e.g., a first multiplexer), which may be coupled with the first signal pad 215, the first conductive path 225-a, and the second conductive path 225-b. The first conductive path 225-a may be coupled with a first input of the first switching component 220. Similarly, the second conductive path 225-b may be coupled with a second input of the first switching component 220. The first signal pad 215 may be coupled with an output of the first switching component 220.

In some implementations, the first switching component may be configured to couple the first signal pad 215 with the first conductive path 225-a or with the second conductive path 225-b (e.g., according to a selection operation or a switching operation based on one or more inputs to the switching component 220). In some cases, the first switching component 220 may be configured to select which conductive path (e.g., the first conductive path 225-a or the second conductive path 225-b) is to be coupled with the first signal pad 215 (e.g., at a bond pad connection). For example, the first switching component 220 may select the first conductive path 225-a or the second conductive path 225-b based on a first performance characteristic associated with one or more first defects of the first conductive path 225-a or based on a second performance characteristic associated with one or more second defects of the second conductive path 225-b.

In some implementations, the architecture 200 may include a substrate 245 at one end of (e.g., below) the memory die 205. The substrate 245 may be in contact with the memory die 205. In some cases, a portion of the mold material 210 may be located between the memory die 205 and the substrate 245. For example, the mold material 210 may be in contact with the memory die 205 and the substrate 245. The set of conductive paths 225 may include (or may be coupled with) a set of conductive vias 240 (e.g., TSVs) extending through at least a portion of the substrate 245. Each conductive path 225 may be coupled with a respective conductive via 240 of the set of conductive vias 240. For example, the first conductive path 225-a may be coupled with a conductive via 240-a and the second conductive path 225-b may be coupled with a conductive via 240-b.

In some implementations, each conductive path 225 may be coupled with the respective conductive via 240 through one or more intermediate components. For example, the first conductive path 225-a may be coupled with a signal pad 230-a (e.g., a bond pad), coupled with a conductive material 235-a (e.g., a conductive pillar, a copper pillar), which may be coupled with the conductive via 240-a. Similarly, the second conductive path 225-b may be coupled with a signal pad 230-b (e.g., a redundant signal pad, a redundant bond pad) coupled with a conductive material 235-b (e.g., a conductive pillar, a copper pillar), which may be coupled with the conductive via 240-b. In any case, the conductive via 240-a and the conductive via 240-b may be coupled with a same access point 250 (e.g., a same solder sphere) of the memory die 205.

In some implementations, multiple signal pads 215 may be coupled with the memory die. Similarly, as illustrated, the architecture 200 may include multiple sets of conductive paths 225 including at least the set of conductive paths 225. Each set of conductive paths 225 may be associated with a respective signal pad 215 of the multiple signal pads 215. As with the set of conductive paths 225, each set of conductive paths 225 of the multiple sets may include at least a respective first conductive path 225 and a respective second conductive path 225. The architecture 200 may further include multiple switching components 220. Each switching component 220 of the multiple switching components 22- may be coupled with a respective signal pad 215, a respective first conductive path 225, and a respective second conductive path 225. Accordingly, each switching component 220 may be configured to select a respective first conductive path 225 or a respective second conductive path 225 to couple with a respective signal pad 215 based on a performance characteristic of a respective first conductive path 225 or a respective second conductive path 225. Techniques described herein in the context of the first signal pad 215 may be equally applied for the multiple signal pads 215.

In some implementations, the memory system 110 may perform one or more operations on the memory die 205 in accordance with aspects as described herein. For example, the memory system 110 may transmit a signal via the first conductive path -225a (e.g., through the switching component 220) associated with the first signal pad 215. The memory system 110 may determine, based on transmitting the signal, whether the first conductive path 225-a has a first performance characteristic associated with one or more defects or a second performance characteristic different than the first performance characteristic (e.g., including no defects or including a relatively low quantity of defects). For example, the memory system 110 may determine (e.g., detect) a quantity of defects of the first conductive path 225-a. In accordance with the determination, the memory system 110 may select, via the first switching component 220, the second conductive path 225-b to couple with the first signal pad 215. In some cases, the memory system 110 may refrain from coupling the first signal pad 215 with the second conductive path 225-b based on the determination (e.g., if the first conductive path 225-a fails to exceed a threshold quantity of defects).

In some cases, the first performance characteristic may be associated with an integrity (e.g., a quality) of the signal. In such cases, the memory system 110 may select the second conductive path 225-b if the signal fails to have an integrity satisfying a threshold integrity when transmitted by the first conductive path 225-a. In some examples, the memory system 110 may select the second conductive path 225-b if the first conductive path 225-a fails to complete a transmission of the signal. In some implementations, the memory system 110 may detect one or more transfer errors associated with the first conductive path 225-a. Accordingly, the memory system 110 may select the second conductive path if the one or more transfer errors satisfy a threshold quantity of transfer errors.

In some cases, the memory system 110 may select a conductive path 225 for coupling with the first signal pad 215 based on a performance of the set of conductive paths. For example, if the first conductive path 225-a has relatively low performance, the memory system 110 may switch to coupling the first signal pad 215 with the second conductive path 225-b. Additionally, or alternatively, the memory system 110 may switch back to coupling the first signal pad 215 with the first conductive path 225-a (e.g., if a performance of the second conductive path 225-b drops below a threshold performance level). In some examples, the memory system 110 may couple the first signal pad 215 with the second conductive path 225-b (e.g., even if the first conductive path 225-a does not include defects). In such cases, the memory system 110 may determine a performance of both the first conductive path 225-a and the second conductive path 225-b, and may select which conductive path to couple with the first signal pad 215 based on a comparison of the performance levels.

In some implementations, the memory system 110 may perform a testing operation on the set of conductive paths 225. The memory system 110 may determine that the first conductive path 225-a has the first performance characteristic based on performing the testing operation. Additionally, or alternatively, the memory system 110 may determine that the second conductive path 225-b has the second performance characteristic based on performing the testing operation. The memory system 110 may select the second conductive path 225-b based on determining that the first conductive path 225-a has the first performance characteristic and that the second conductive path 225-b has the second performance characteristic. For example, the memory system 110 may select the second conductive path 225-b if a performance value (e.g., a signaling performance capability) of the second conductive path 225-b is greater than a performance value of the first conductive path 225-a. Additionally, or alternatively, the memory system 110 may select the second conductive path 225-b without determining that the second conductive path 225-b has the second performance characteristic. For example, if the first conductive path 225-a has a first performance characteristic that fails to satisfy a threshold performance level, the memory system 110 may select the second conductive path 225-b (e.g., without any performance analysis of the second conductive path 225-b). In some cases, the memory system 110 may perform a set of periodic testing operations on the set of conductive paths 225 (e.g., including the testing operation). In such cases, the memory system 110 may determine that the second conductive path 225-b has the second performance characteristic based on performing the set of periodic testing operations. In some examples, the memory system 110 may detect one or more errors associated with the memory die 205. Accordingly, the memory system 110 may perform the testing operation based on (e.g., in response to) the one or more errors satisfying a threshold quantity of errors.

In some implementations, the memory system 110 may receive an indication to perform a repair operation on the first conductive path 225-a. For example, a host system 105 (or another device) may send the indication to perform the repair operation based on one or more measurements or properties (e.g., an error rate, defects, transfer failures) associated with the first conductive path 225-a. In any case, the memory system 110 may select the second conductive path 225-b in accordance with the indication to perform the repair operation on the first conductive path 225-a. Accordingly, the memory system 110 may reselect to a redundant conductive path to repair a fault conductive path.

In some implementations, the memory system 110 may transmit a second signal via a third conductive path 225 of a second set of conductive paths 225 associated with a second signal pad 215 of the memory die 205. The second set of conductive paths 225 may include at least the third conductive path 225 and a fourth conductive path 225. The memory system 110 may determine, based on transmitting the second signal, whether the third conductive path 225 has the first performance characteristic or the second performance characteristic. If the third conductive path 225 has the second performance characteristic, the memory system 110 may select, via a second switching component 220, the third conductive path 225 of the set of conductive paths 225 to couple with the second signal pad 215.

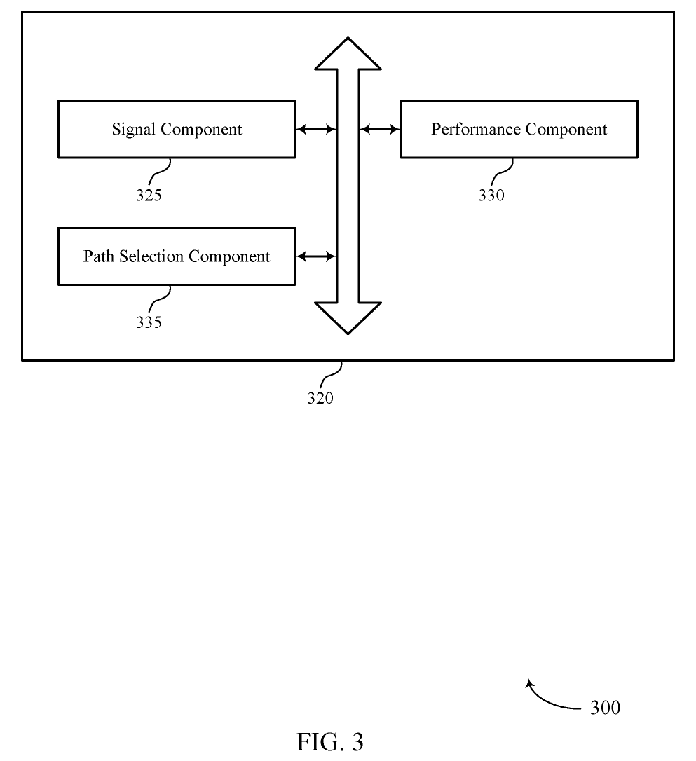

FIG. 3 shows a block diagram 300 of a memory system 320 that supports via repair using redundant vias in accordance with examples as disclosed herein. The memory system 320 may be an example of aspects of a memory system as described with reference to FIGS. 1 - 2. The memory system 320, or various components thereof, may be an example of means for performing (e.g., to cause the memory system 320 to perform) various aspects of via repair using redundant vias as described herein. For example, the memory system 320 may include a signal component 325, a performance component 330, a path selection component 335, or any combination thereof. Each of these components, or components of subcomponents thereof (e.g., one or more processors, one or more memories), may communicate, directly or indirectly, with one another (e.g., via one or more buses).

The signal component 325 may be configured as or otherwise support a means for transmitting a signal via a first conductive path of a set of conductive paths associated with a first signal pad of a memory die, the set of conductive paths including at least the first conductive path and a second conductive path. The performance component 330 may be configured as or otherwise support a means for determining, based at least in part on transmitting the signal, whether the first conductive path includes a first performance characteristic associated with one or more defects or a second performance characteristic different than the first performance characteristic. The path selection component 335 may be configured as or otherwise support a means for selecting, via a first switching component, the second conductive path of the set of conductive paths to couple with the first signal pad based at least in part on determining that the first conductive path includes (e.g., has) the first performance characteristic.

In some examples, selecting the second conductive path is based at least in part on the first conductive path failing to complete transmission of the signal.

In some examples, the performance component 330 may be configured as or otherwise support a means for detecting one or more transfer errors associated with the first conductive path, where selecting the second conductive path is based at least in part on the one or more transfer errors satisfying a threshold quantity of transfer errors.

In some examples, the performance component 330 may be configured as or otherwise support a means for performing a testing operation on the set of conductive paths, where determining that the first conductive path includes (e.g., has) the first performance characteristic is based at least in part on performing the testing operation. In some examples, the performance component 330 may be configured as or otherwise support a means for determining that the second conductive path includes (e.g., has) the second performance characteristic based at least in part on performing the testing operation, where selecting the second conductive path is based at least in part on determining that the first conductive path includes (e.g., has) the first performance characteristic and the second conductive path includes (e.g., has) the second performance characteristic.

In some examples, the performance component 330 may be configured as or otherwise support a means for performing a set of periodic testing operations on the set of conductive paths, where determining that the second conductive path includes (e.g., has) the second performance characteristic is based at least in part on performing the set of periodic testing operations.

In some examples, the performance component 330 may be configured as or otherwise support a means for detecting one or more errors associated with the memory die, where performing the testing operation is based at least in part on the one or more errors satisfying a threshold quantity of errors.

In some examples, the path selection component 335 may be configured as or otherwise support a means for receiving an indication to perform a repair operation on the first conductive path, where selecting the second conductive path is in accordance with receiving the indication to perform the repair operation on the first conductive path.

In some examples, the signal component 325 may be configured as or otherwise support a means for transmitting a second signal via a third conductive path of a second set of conductive paths associated with a second signal pad of the memory die, the second set of conductive paths including at least the third conductive path and a fourth conductive path. In some examples, the performance component 330 may be configured as or otherwise support a means for determining, based at least in part on transmitting the second signal, whether the third conductive path includes (e.g., has) the first performance characteristic or the second performance characteristic. In some examples, the path selection component 335 may be configured as or otherwise support a means for selecting, via a second switching component, the third conductive path of the set of conductive paths to couple with the second signal pad based at least in part on determining that the third conductive path includes (e.g., has) the second performance characteristic.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 320 to perform one or more operations. In some examples, the described functionality of the memory system 320, or various components thereof, may be implemented at least in part by instructions (e.g., stored in memory, non-transitory computer-readable medium) executable by such at least one processor to cause the memory system 320 to perform one or more operations.

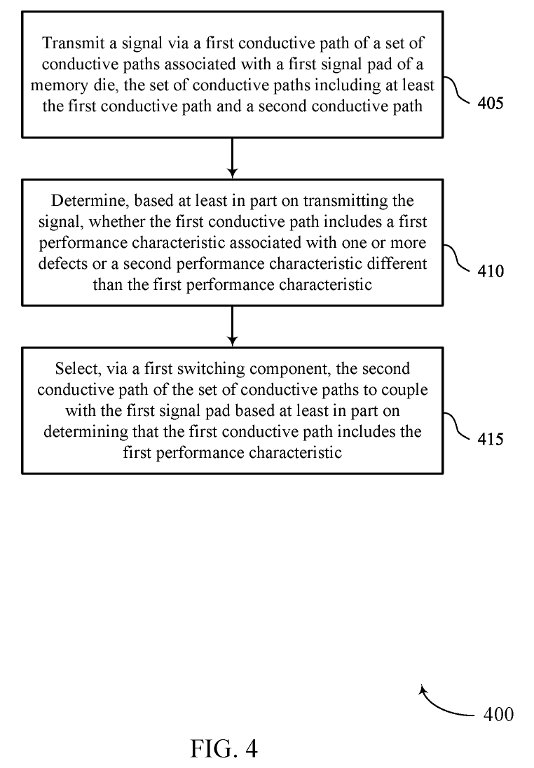

FIG. 4 shows a flowchart illustrating a method 400 that supports via repair using redundant vias in accordance with examples as disclosed herein. The operations of method 400 may be implemented by a memory system or its components as described herein. For example, the operations of method 400 may be performed by a memory system as described with reference to FIGS. 1 - 3. In some examples, a memory system may execute a set of instructions to control the functional elements of the device to perform the described functions. Additionally, or alternatively, the memory system may perform aspects of the described functions using special-purpose hardware.

At 405, the method may include transmitting a signal via a first conductive path of a set of conductive paths associated with a first signal pad of a memory die, the set of conductive paths including at least the first conductive path and a second conductive path. In some examples, aspects of the operations of 405 may be performed by a signal component 325.

At 410, the method may include determining, based at least in part on transmitting the signal, whether the first conductive path includes a first performance characteristic associated with one or more defects or a second performance characteristic different than the first performance characteristic. In some examples, aspects of the operations of 410 may be performed by a performance component 330.

At 415, the method may include selecting, via a first switching component, the second conductive path of the set of conductive paths to couple with the first signal pad based at least in part on determining that the first conductive path includes (e.g., has) the first performance characteristic. In some examples, aspects of the operations of 415 may be performed by a path selection component 335.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for transmitting a signal via a first conductive path of a set of conductive paths associated with a first signal pad of a memory die, the set of conductive paths including at least the first conductive path and a second conductive path; determining, based at least in part on transmitting the signal, whether the first conductive path includes a first performance characteristic associated with one or more defects or a second performance characteristic different than the first performance characteristic; and selecting, via a first switching component, the second conductive path of the set of conductive paths to couple with the first signal pad based at least in part on determining that the first conductive path includes (e.g., has) the first performance characteristic.
Aspect 2: The method, apparatus, or non-transitory computer-readable medium of aspect 1, where selecting the second conductive path is based at least in part on the first conductive path failing to complete transmission of the signal.
Aspect 3: The method, apparatus, or non-transitory computer-readable medium of any of aspects 1 through 2, further including operations, features, circuitry, logic, means, or instructions, or any combination thereof for detecting one or more transfer errors associated with the first conductive path, where selecting the second conductive path is based at least in part on the one or more transfer errors satisfying a threshold quantity of transfer errors.
Aspect 4: The method, apparatus, or non-transitory computer-readable medium of any of aspects 1 through 3, further including operations, features, circuitry, logic, means, or instructions, or any combination thereof for performing a testing operation on the set of conductive paths, where determining that the first conductive path includes (e.g., has) the first performance characteristic is based at least in part on performing the testing operation and determining that the second conductive path includes (e.g., has) the second performance characteristic based at least in part on performing the testing operation, where selecting the second conductive path is based at least in part on determining that the first conductive path includes (e.g., has) the first performance characteristic and the second conductive path includes (e.g., has) the second performance characteristic.
Aspect 5: The method, apparatus, or non-transitory computer-readable medium of aspect 4, further including operations, features, circuitry, logic, means, or instructions, or any combination thereof for performing a set of periodic testing operations on the set of conductive paths, where determining that the second conductive path includes (e.g., has) the second performance characteristic is based at least in part on performing the set of periodic testing operations.
Aspect 6: The method, apparatus, or non-transitory computer-readable medium of any of aspects 4 through 5, further including operations, features, circuitry, logic, means, or instructions, or any combination thereof for detecting one or more errors associated with the memory die, where performing the testing operation is based at least in part on the one or more errors satisfying a threshold quantity of errors.
Aspect 7: The method, apparatus, or non-transitory computer-readable medium of any of aspects 1 through 6, further including operations, features, circuitry, logic, means, or instructions, or any combination thereof for receiving an indication to perform a repair operation on the first conductive path, where selecting the second conductive path is in accordance with receiving the indication to perform the repair operation on the first conductive path.
Aspect 8: The method, apparatus, or non-transitory computer-readable medium of any of aspects 1 through 7, further including operations, features, circuitry, logic, means, or instructions, or any combination thereof for transmitting a second signal via a third conductive path of a second set of conductive paths associated with a second signal pad of the memory die, the second set of conductive paths including at least the third conductive path and a fourth conductive path; determining, based at least in part on transmitting the second signal, whether the third conductive path includes (e.g., has) the first performance characteristic or the second performance characteristic; and selecting, via a second switching component, the third conductive path of the set of conductive paths to couple with the second signal pad based at least in part on determining that the third conductive path includes (e.g., has) the second performance characteristic.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 9: An apparatus, including: a memory die; a first signal pad coupled with the memory die; a set of conductive paths associated with the first signal pad, the set of conductive paths including at least a first conductive path and a second conductive path; and a first switching component coupled with the first signal pad, the first conductive path, and the second conductive path, where the first switching component is configured to select the first conductive path or the second conductive path to couple with the first signal pad based at least in part on a performance characteristic associated with one or more defects of the first conductive path or the second conductive path.
Aspect 10: The apparatus of aspect 9, further including: a substrate below the memory die, where the set of conductive paths include a set of conductive vias extending through at least a portion of the substrate.
Aspect 11: The apparatus of any of aspects 9 through 10, further including: a set of memory elements within the memory die, where the first signal pad is coupled with at least a first memory element of the set of memory elements.
Aspect 12: The apparatus of any of aspects 9 through 11, further including: a plurality of signal pads coupled with the memory die; a plurality of sets of conductive paths including at least the set of conductive paths, each set of conductive paths associated with a respective signal pad of the plurality of signal pads, where each set of conductive paths includes at least a respective first conductive path and a respective second conductive path; and a plurality of switching components, each switching component of the plurality of switching components coupled with a respective signal pad, a respective first conductive path, and a respective second conductive path, where each switching component is configured to select a respective first conductive path or a respective second conductive path to couple with a respective signal pad based at least in part on a performance characteristic of a respective first conductive path or a respective second conductive path.
Aspect 13: The apparatus of any of aspects 9 through 12, where the first conductive path and the second conductive path are coupled with a same access point of the memory die.
Aspect 14: The apparatus of any of aspects 9 through 13, where the first conductive path is coupled with a first input of the first switching component, the second conductive path is coupled with a second input of the first switching component, and the first signal pad is coupled with an output of the first switching component.

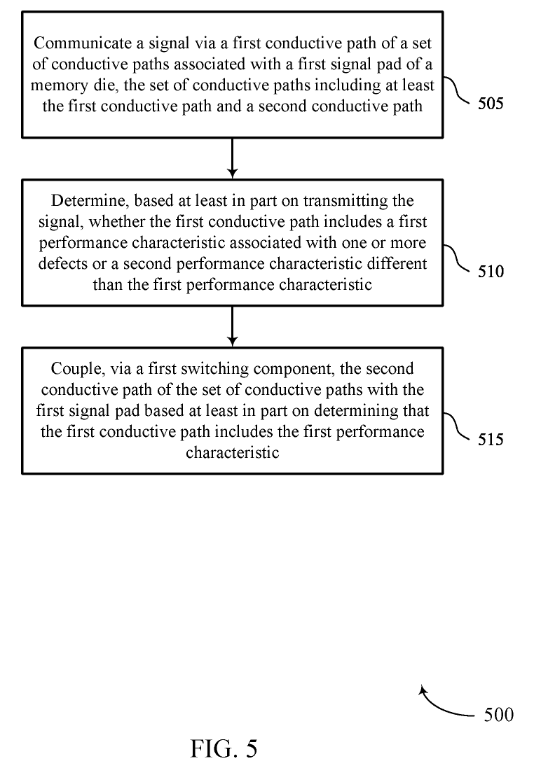

FIG. 5 shows a flowchart illustrating a method 500 that supports via repair using redundant vias in accordance with examples as disclosed herein. The operations of method 500 may be implemented by a memory system or its components as described herein. For example, the operations of method 500 may be performed by a memory system as described with reference to FIGS. 1 - 3. In some examples, a memory system may execute a set of instructions to control the functional elements of the device to perform the described functions. Additionally, or alternatively, the memory system may perform aspects of the described functions using special-purpose hardware.

At 505, the method may include communicating a signal via a first conductive path of a set of conductive paths associated with a first signal pad of a memory die, the set of conductive paths including at least the first conductive path and a second conductive path. In some examples, aspects of the operations of 505 may be performed by a communication component 340.

At 510, the method may include determining, based at least in part on transmitting the signal, whether the first conductive path includes a first performance characteristic associated with one or more defects or a second performance characteristic different than the first performance characteristic. In some examples, aspects of the operations of 510 may be performed by a determination component 345.

At 515, the method may include coupling, via a first switching component, the second conductive path of the set of conductive paths with the first signal pad based at least in part on determining that the first conductive path includes the first performance characteristic. In some examples, aspects of the operations of 515 may be performed by a coupling component 350.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 15: A method, apparatus, or non-transitory computer-readable medium including operations, features, circuitry, logic, means, or instructions, or any combination thereof for communicating a signal via a first conductive path of a set of conductive paths associated with a first signal pad of a memory die, the set of conductive paths including at least the first conductive path and a second conductive path; determining, based at least in part on transmitting the signal, whether the first conductive path includes a first performance characteristic associated with one or more defects or a second performance characteristic different than the first performance characteristic; and coupling, via a first switching component, the second conductive path of the set of conductive paths with the first signal pad based at least in part on determining that the first conductive path includes the first performance characteristic.
Aspect 16: The method, apparatus, or non-transitory computer-readable medium of aspect 15, where the first performance characteristic is associated with a completion of transmission of the signal and coupling the second conductive path with the first signal pad is based at least in part on the first conductive path failing to complete the transmission of the signal.
Aspect 17: The method, apparatus, or non-transitory computer-readable medium of any of aspects 15 through 16, further including operations, features, circuitry, logic, means, or instructions, or any combination thereof for determining a quantity of one or more transfer errors associated with the first conductive path, where coupling the second conductive path with the first signal pad is based at least in part on the quantity of one or more transfer errors satisfying a threshold quantity of transfer errors.
Aspect 18: The method, apparatus, or non-transitory computer-readable medium of any of aspects 15 through 17, further including operations, features, circuitry, logic, means, or instructions, or any combination thereof for performing a testing operation on the set of conductive paths, where determining that the first conductive path includes the first performance characteristic is based at least in part on performing the testing operation and determining that the second conductive path includes the second performance characteristic based at least in part on performing the testing operation, where coupling the second conductive path with the first signal pad is based at least in part on determining that the first conductive path includes the first performance characteristic and the second conductive path includes the second performance characteristic.
Aspect 19: The method, apparatus, or non-transitory computer-readable medium of aspect 18, further including operations, features, circuitry, logic, means, or instructions, or any combination thereof for performing a set of periodic testing operations on the set of conductive paths in accordance with a repair operation periodicity, where determining that the second conductive path includes the second performance characteristic is based at least in part on performing the set of periodic testing operations.
Aspect 20: The method, apparatus, or non-transitory computer-readable medium of any of aspects 18 through 19, further including operations, features, circuitry, logic, means, or instructions, or any combination thereof for determining a quantity of one or more errors associated with the memory die, where performing the testing operation is based at least in part on the quantity of one or more errors satisfying a threshold quantity of errors.
Aspect 21: The method, apparatus, or non-transitory computer-readable medium of any of aspects 15 through 20, further including operations, features, circuitry, logic, means, or instructions, or any combination thereof for obtaining an indication to perform a repair operation on the first conductive path, where coupling the second conductive path with the first signal pad is in accordance with obtaining the indication to perform the repair operation on the first conductive path.
Aspect 22: The method, apparatus, or non-transitory computer-readable medium of any of aspects 15 through 21, further including operations, features, circuitry, logic, means, or instructions, or any combination thereof for communicating a second signal via a third conductive path of a second set of conductive paths associated with a second signal pad of the memory die, the second set of conductive paths including at least the third conductive path and a fourth conductive path; determining, based at least in part on transmitting the second signal, whether the third conductive path includes the first performance characteristic or the second performance characteristic; and coupling, via a second switching component, the third conductive path of the set of conductive paths with the second signal pad based at least in part on determining that the third conductive path includes the second performance characteristic.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 23: An apparatus, including: a memory die; a first signal pad coupled with the memory die; a set of conductive paths associated with the first signal pad, the set of conductive paths including at least a first conductive path and a second conductive path; and a first switching component coupled with the first signal pad, the first conductive path, and the second conductive path, where the first switching component is configured to select the first conductive path or the second conductive path to couple with the first signal pad based at least in part on a performance characteristic associated with one or more defects of the first conductive path or the second conductive path.
Aspect 24: The apparatus of aspect 9, further including: a substrate below the memory die, where the set of conductive paths include a set of conductive vias extending through at least a portion of the substrate.
Aspect 25: The apparatus of any of aspects 9 through 10, further including: a set of memory elements within the memory die, where the first signal pad is coupled with at least a first memory element of the set of memory elements.
Aspect 26: The apparatus of any of aspects 9 through 11, further including: a plurality of signal pads coupled with the memory die; a plurality of sets of conductive paths including at least the set of conductive paths, each set of conductive paths associated with a respective signal pad of the plurality of signal pads, where each set of conductive paths includes at least a respective first conductive path and a respective second conductive path; and a plurality of switching components, each switching component of the plurality of switching components coupled with a respective signal pad, a respective first conductive path, and a respective second conductive path, where each switching component is configured to select a respective first conductive path or a respective second conductive path to couple with a respective signal pad based at least in part on a performance characteristic of a respective first conductive path or a respective second conductive path.
Aspect 27: The apparatus of any of aspects 9 through 12, where the first conductive path and the second conductive path are coupled with a same access point of the memory die.
Aspect 28: The apparatus of any of aspects 9 through 13, where the first conductive path is coupled with a first input of the first switching component, the second conductive path is coupled with a second input of the first switching component, and the first signal pad is coupled with an output of the first switching component

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory die;
a first signal pad coupled with the memory die;
a set of conductive paths associated with the first signal pad, the set of conductive paths comprising at least a first conductive path and a second conductive path; and
a first switching component coupled with the first signal pad, the first conductive path, and the second conductive path, wherein the first switching component is configured to select the first conductive path or the second conductive path to couple with the first signal pad based at least in part on a performance characteristic associated with one or more defects of the first conductive path or the second conductive path.

2. The apparatus of claim 1, further comprising:
a substrate below the memory die, wherein the set of conductive paths comprise a set of conductive vias extending through at least a portion of the substrate.

3. The apparatus of claim 1, further comprising:
a set of memory elements within the memory die, wherein the first signal pad is coupled with at least a first memory element of the set of memory elements.

4. The apparatus of claim 1, further comprising:
a plurality of signal pads coupled with the memory die;
a plurality of sets of conductive paths comprising at least the set of conductive paths, each set of conductive paths associated with a respective signal pad of the plurality of signal pads, wherein each set of conductive paths comprises at least a respective first conductive path and a respective second conductive path; and
a plurality of switching components, each switching component of the plurality of switching components coupled with a respective signal pad, a respective first conductive path, and a respective second conductive path, wherein each switching component is configured to select a respective first conductive path or a respective second conductive path to couple with a respective signal pad based at least in part on a performance characteristic of a respective first conductive path or a respective second conductive path.

5. The apparatus of claim 1, wherein the first conductive path and the second conductive path are coupled with a same access point of the memory die.

6. The apparatus of claim 1, wherein:
the first conductive path is coupled with a first input of the first switching component,
the second conductive path is coupled with a second input of the first switching component, and
the first signal pad is coupled with an output of the first switching component.

7. A memory system, comprising:
one or more memory devices; and
processing circuitry coupled with the one or more memory devices and configured to cause the memory system to:
transmit a signal via a first conductive path of a set of conductive paths associated with a first signal pad of a memory die, the set of conductive paths comprising at least the first conductive path and a second conductive path;
determine, based at least in part on transmitting the signal, whether the first conductive path comprises a first performance characteristic associated with one or more defects or a second performance characteristic different than the first performance characteristic; and
select, via a first switching component, the second conductive path of the set of conductive paths to couple with the first signal pad based at least in part on determining that the first conductive path comprises the first performance characteristic.

8. The memory system of claim 7, wherein selecting the second conductive path is based at least in part on the first conductive path failing to complete transmission of the signal.

9. The memory system of claim 7, wherein the processing circuitry is further configured to cause the memory system to:
detect one or more transfer errors associated with the first conductive path, wherein selecting the second conductive path is based at least in part on the one or more transfer errors satisfying a threshold quantity of transfer errors.

10. The memory system of claim 7, wherein the processing circuitry is further configured to cause the memory system to:
perform a testing operation on the set of conductive paths, wherein determining that the first conductive path comprises the first performance characteristic is based at least in part on performing the testing operation; and
determine that the second conductive path comprises the second performance characteristic based at least in part on performing the testing operation, wherein selecting the second conductive path is based at least in part on determining that the first conductive path comprises the first performance characteristic and the second conductive path comprises the second performance characteristic.

11. The memory system of claim 10, wherein the processing circuitry is further configured to cause the memory system to:
perform a set of periodic testing operations on the set of conductive paths, wherein determining that the second conductive path comprises the second performance characteristic is based at least in part on performing the set of periodic testing operations.

12. The memory system of claim 10, wherein the processing circuitry is further configured to cause the memory system to:
detect one or more errors associated with the memory die, wherein performing the testing operation is based at least in part on the one or more errors satisfying a threshold quantity of errors.

13. The memory system of claim 7, wherein the processing circuitry is further configured to cause the memory system to:
receive an indication to perform a repair operation on the first conductive path, wherein selecting the second conductive path is in accordance with receiving the indication to perform the repair operation on the first conductive path.

14. The memory system of claim 7, wherein the processing circuitry is further configured to cause the memory system to:
transmit a second signal via a third conductive path of a second set of conductive paths associated with a second signal pad of the memory die, the second set of conductive paths comprising at least the third conductive path and a fourth conductive path;
determine, based at least in part on transmitting the second signal, whether the third conductive path comprises the first performance characteristic or the second performance characteristic; and
select, via a second switching component, the third conductive path of the set of conductive paths to couple with the second signal pad based at least in part on determining that the third conductive path comprises the second performance characteristic.

15. A method by a memory system, comprising:
communicating a signal via a first conductive path of a set of conductive paths associated with a first signal pad of a memory die, the set of conductive paths comprising at least the first conductive path and a second conductive path;
determining, based at least in part on transmitting the signal, whether the first conductive path comprises a first performance characteristic associated with one or more defects or a second performance characteristic different than the first performance characteristic; and
coupling, via a first switching component, the second conductive path of the set of conductive paths with the first signal pad based at least in part on determining that the first conductive path comprises the first performance characteristic.

16. The method of claim 15, wherein the first performance characteristic is associated with a completion of transmission of the signal, wherein coupling the second conductive path with the first signal pad is based at least in part on the first conductive path failing to complete the transmission of the signal.

17. The method of claim 15, further comprising:
determining a quantity of one or more transfer errors associated with the first conductive path, wherein coupling the second conductive path with the first signal pad is based at least in part on the quantity of one or more transfer errors satisfying a threshold quantity of transfer errors.

18. The method of claim 15, further comprising:
performing a testing operation on the set of conductive paths, wherein determining that the first conductive path comprises the first performance characteristic is based at least in part on performing the testing operation; and
determining that the second conductive path comprises the second performance characteristic based at least in part on performing the testing operation, wherein coupling the second conductive path with the first signal pad is based at least in part on determining that the first conductive path comprises the first performance characteristic and the second conductive path comprises the second performance characteristic.

19. The method of claim 18, further comprising:
performing a set of periodic testing operations on the set of conductive paths in accordance with a repair operation periodicity, wherein determining that the second conductive path comprises the second performance characteristic is based at least in part on performing the set of periodic testing operations.

20. The method of claim 18, further comprising:
determining a quantity of one or more errors associated with the memory die, wherein performing the testing operation is based at least in part on the quantity of one or more errors satisfying a threshold quantity of errors.

21. The method of claim 15, further comprising:
obtaining an indication to perform a repair operation on the first conductive path, wherein coupling the second conductive path with the first signal pad is in accordance with obtaining the indication to perform the repair operation on the first conductive path.

22. The method of claim 15, further comprising:
communicating a second signal via a third conductive path of a second set of conductive paths associated with a second signal pad of the memory die, the second set of conductive paths comprising at least the third conductive path and a fourth conductive path;
determining, based at least in part on transmitting the second signal, whether the third conductive path comprises the first performance characteristic or the second performance characteristic; and
coupling, via a second switching component, the third conductive path of the set of conductive paths with the second signal pad based at least in part on determining that the third conductive path comprises the second performance characteristic.
